(19) United States
(12) Patent Application Publication
(10) Pub. No.: US 2013/0017019 A1
(43) Pub. Date: Jan. 17, 2013

(54) Laying Ramp, Laying Unit Comprising Such a Laying Ramp, and Method of Operating Such a Laying Unit

(71) Applicants: Stefano Bianchi, Cermusco sul Naviglio (IT); Flavio Piccio, Milano (IT); Umberto Giovannini, Corsico (IT); Mauro Mottini, Travaco' Siccomario (IT)

(72) Inventors: Stefano Bianchi, Cermusco sul Naviglio (IT); Flavio Piccio, Milano (IT); Umberto Giovannini, Corsico (IT); Mauro Mottini, Travaco' Siccomario (IT)

(73) Assignee: SAIPEM S.p.A., San Donato Milanese (IT)

(21) Appl. No.: 13/518,690

(22) PCT Filed: Dec. 23, 2010
(86) PCT No.: PCT/IB2010/003343

§ 371 Date: Sep. 26, 2012

(30) Foreign Application Priority Data
Dec. 24, 2009 (IT) TO2009A001043

(51) Int. Cl. F16L 1/14

(52) U.S. Cl. 405/166

(57) ABSTRACT

A laying ramp for laying a pipeline on the bed of a body of water can include an elongated frame having a first and second end; connecting members connecting the first end of the elongated frame to a vessel; at least one guide device fitted to the elongated frame to guide the pipeline along the elongated frame; and a support assembly, which has at least one undercarriage to roll along the bed of the body of water and support the second end of the elongated frame.

### TECHNICAL FIELD

The present invention relates to a laying ramp for laying a pipeline on the bed of a body of water.

### BACKGROUND ART

A laying ramp normally comprises an elongated frame with a first and second end; connecting members for connecting the first end of the elongated frame to a vessel; and at least one guide device fitted to the elongated frame to support and guide the pipeline along the elongated frame.

A vessel for laying a pipeline on the bed of a body of water is a floating body, which comprises a pipeline assembly line, and is connected at the stern to the laying ramp, which defines a continuation of the assembly line, and provides for launching and easing the pipeline onto the bed as the vessel moves forward.

The method used to produce and launch the pipeline comprises assembling it on a substantially horizontal assembly line, and laying it by means of the laying ramp, which, in the work configuration, serves to guide and support the pipeline along a curved path extending partly above and partly below the surface of the water. Pipelines laid using this method assume an S shape between the vessel and the bed, the radius of curvature of the two curves of which depends on the stiffness of the pipeline, the length and configuration of the laying ramp, and the depth of the body of water. This laying method can be employed by various types of vessels, such as pontoons, barges, semisubmersibles and single-hull ships, depending on the depth of the bed, weather conditions, and the type of project. Pontoons and barges are the most commonly used for laying pipelines in shallow water; semisubmersibles are more suitable for pipeline laying in difficult weather and climate conditions; whereas single-hull ships have the added advantage of being fast-moving, and having more space for pipe storage and relatively long, and therefore higher-output, production lines.

Pipeline laying normally calls for fairly smooth water conditions, and in fact is temporarily suspended in extreme conditions; in which case, the completed part of the pipeline is released onto the bed and connected to a winch cable for recovery later, and the laying ramp is raised and positioned as far away as possible from the surface of the water, in what is known as a “survival configuration”.

The laying ramp normally comprises a frame, which has a first portion hinged to the vessel, and a second portion hinged to the first portion, and can assume various operating positions, depending on the depth of the bed and the characteristics of the pipeline; a transit configuration, in which the first and second portion allow unimpeded movement of the vessel; and said “survival configuration”. Accordingly, the laying ramp is connected to the vessel by an actuating assembly, as described, for example, in U.S. Pat. No. 4,257,718, WO 2008/149210, and WO 2009/098586 filed by the Applicant, and in which the second portion of the frame is supported, projecting, by arms connected to the vessel.

When laying the pipeline, both the vessel and the pipeline itself are subjected to stress by the body of water. On the one hand, the vessel, despite being maintained in position and moved in steps along a given course by a system of mooring lines, or positioned dynamically by thrusters, is still subject to undesired movements caused by waves and currents in the water.

On the other, the pipeline is also subjected to the same waves and currents, but, because of the different shape and weight of the vessel and the pipeline, and the fact that the pipeline is substantially flexible and partly resting on the bed, the waves and currents produce additional stress between the laying ramp and the pipeline.

This additional stress may result in severe loads being transmitted between the laying ramp and the pipeline, and may impair the structural integrity of the ramp as a whole and/or of the pipeline.

The size and structure of the laying ramp and vessels in U.S. Pat. No. 4,257,718, WO 2008/149210 and WO 2009/098586 obviously make them unsuitable for pipeline laying in shallow water, particularly with a bed of varying topography. Pipeline laying in shallow water calls for vessels with a shallow draft, which therefore lack many of the cranes and other equipment installed on other vessels.

The weight of the pipeline and the laying ramp may also have an unbalancing effect, which is addressed by supporting the second end of the laying ramp with airtight controlled-buoyancy tanks, as described, for example, in U.S. Pat. No. 4,030,311, 3,670,511, 3,606,759, 3,538,712 and 3,507,126.

The laying ramp in the above documents, however, is unsuitable for operating in very shallow water with a bed of varying topography. In fact, pipelines sometimes have to be laid in water of an average depth of 4 metres, and varying between 1.5 and 10 metres. In which case, the controlled-buoyancy tanks would have to be extremely large, and, apart from their size and weight, controlling them to adjust their depth would be incompatible with other pipeline laying operations.

Another drawback is that, in shallow water, the pipeline forms two opposite curves along a relatively short portion of the pipeline.

Moreover, all the above drawbacks are further aggravated alongside an increase in the specific weight of the pipeline.

U.S. Pat. No. 3,280,571 describes a laying ramp which partly solves the above drawbacks by comprising slides located on its free end, and which rest on the bed of the body of water.

The laying ramp in U.S. Pat. No. 3,280,571, however, can only be operated on certain types of beds, and can only be moved in the laying direction, in that, in the opposite direction, the slides may sink into the bed and knock the ramp out of line with respect to the vessel.

### DISCLOSURE OF INVENTION

One object of the present invention is to provide a laying ramp, for laying a pipeline on the bed of a body of water, designed to minimize the drawbacks of the known art, and in particular to operate effectively in very shallow water with any type of bed.

Another object of the present invention is to provide a laying ramp, for laying a pipeline on the bed of a body of water, designed to reduce stress between the pipeline and the ramp.

Another object of the present invention is to provide a laying ramp, for laying a pipeline on the bed of a body of water, which can also be moved in the opposite direction to the laying direction in very shallow water.

According to the present invention, there is provided a laying ramp for laying a pipeline on the bed of a body of water, the laying ramp comprising an elongated frame having a first and second end; connecting members connecting the first end of the elongated frame to a vessel; at least one guide device fitted to the elongated frame to guide the pipeline along the elongated frame; and a support assembly, in turn comprising at least one undercarriage to roll along the bed of the body of water and support the second end of the elongated frame.

By virtue of the present invention, the laying ramp is supported stably at both ends, and reduces drag by adapting automatically to variations in the depth of the bed of the body of water. The laying ramp also supports the pipeline evenly between the vessel and the bed of the body of water, with no excessively long, uncontrolled spans of pipeline; and the rolling movement produces less drag, and is easily assisted by a motor.

Reducing drag reduces the risk of misalignment between the laying ramp and vessel when moving in the opposite direction to the laying direction.

Another object of the present invention is to provide a laying unit designed to eliminate the drawbacks of the known art.

According to the present invention, there is provided a laying unit for laying a pipeline on the bed of a body of water, the laying unit comprising a vessel movable on the body of water; and a laying ramp as described above; the laying ramp being supported partly by the vessel, and partly resting on the bed of the body of water.

Another object of the present invention is to provide a laying unit operating method designed to eliminate the drawbacks of the known art.

According to the present invention, there is provided a method of operating a laying unit, wherein the laying unit comprises a vessel; and a laying ramp which is supported partly by the vessel, rests partly on the bed of the body of water, and comprises an elongated frame with a first and second end, a guide device fitted to the elongated frame, and a support assembly for supporting the second end of the elongated frame; the method comprising the step of rolling the support assembly along the bed of the body of water.

### BRIEF DESCRIPTION OF THE DRAWINGS

A non-limiting embodiment of the present invention will be described by way of example with reference to the accompanying drawings, in which:

FIG. 1 shows a partly sectioned side view, with parts removed for clarity, of a laying unit comprising a laying ramp in accordance with the present invention, and recovering a pipeline abandoned on the bed of a body of water;

FIG. 2 shows a view in perspective, with parts removed for clarity, of the FIG. 1 laying unit;

FIGS. 3, 4, 5 and 6 show partly sectioned side views, with parts removed for clarity, of the FIG. 1 laying unit at various pipeline recovery stages;

FIG. 7 shows a schematic side view, with parts removed for clarity, of the FIG. 1 laying unit in a laying configuration and associated with a control system.

### BEST MODE FOR CARRYING OUT THE INVENTION

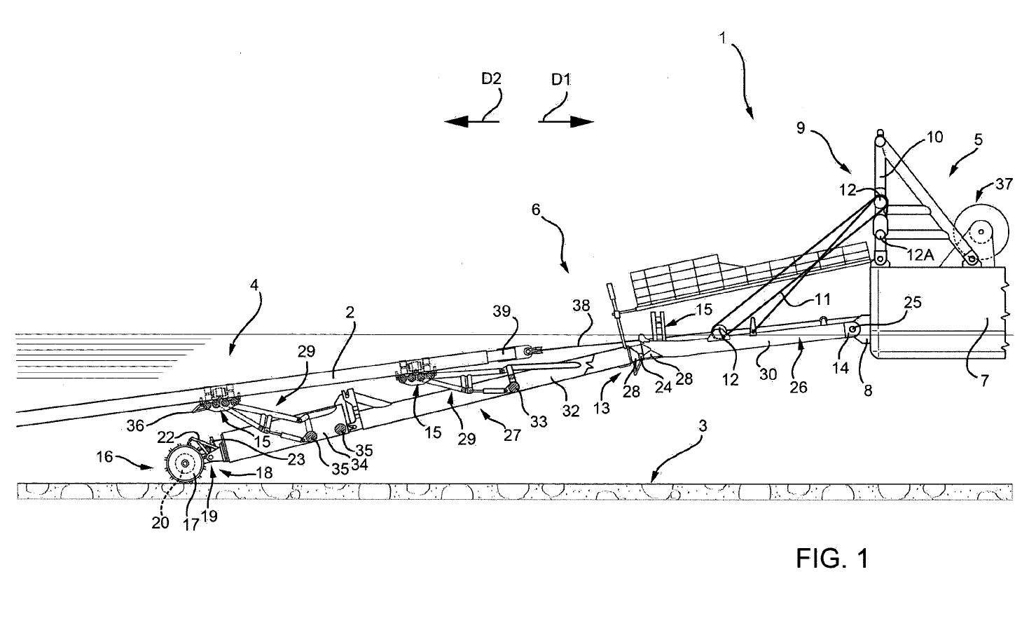

Number 1 in FIG. 1 indicates as a whole a laying unit for laying a pipeline 2 on the bed 3 of a body of water 4.

Laying unit 1 comprises a vessel 5; and a laying ramp 6 connected to the stern of vessel 5.

Vessel 5 is preferably a barge, and comprises a shallow-draft hull 7 for operating in very shallow water; an attachment 8 for connecting laying ramp 6; a control mechanism 9 for controlling laying ramp 6; and an assembly line (not shown) for assembling pipeline 2.

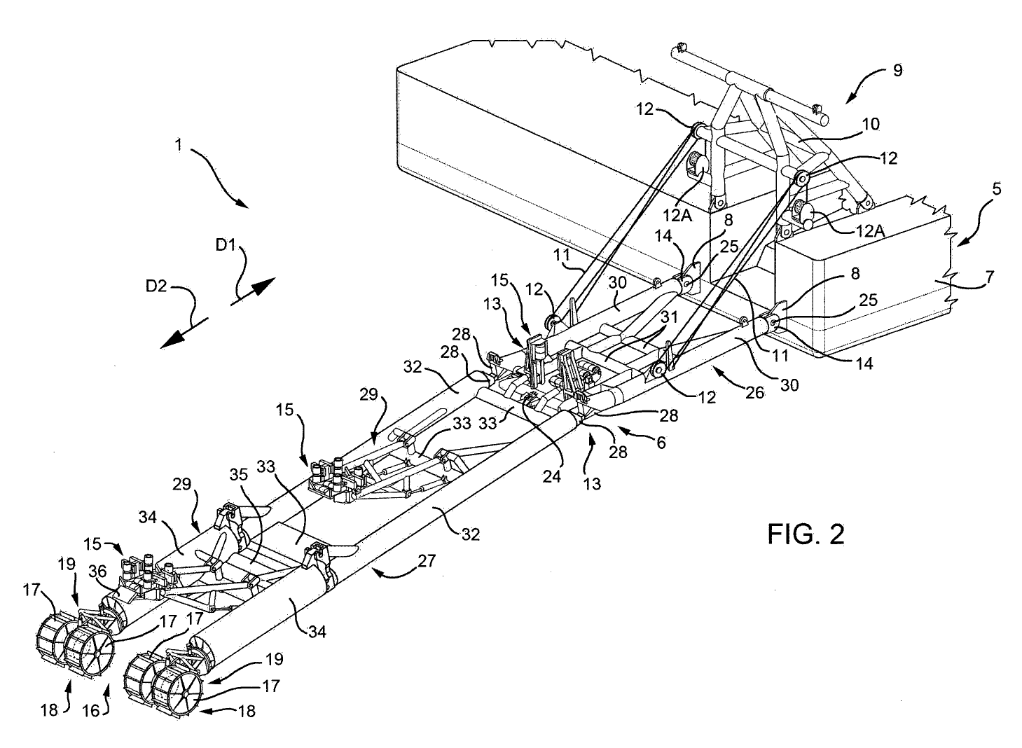

As shown more clearly in FIG. 2, control mechanism 9 comprises a gantry 10 at the stern of vessel 5, over a well in hull 7 to permit passage of pipeline 2; and cables 11 connected to laying ramp 6 and gantry 10 by pulleys 12 and winches 12A for controlling the cables and at least partly controlling the configuration of laying ramp 6.

Laying ramp 6 comprises an elongated frame 13 with a first and second end; connecting members 14 for connecting the first end of elongated frame 13 to vessel 5; three guide devices 15 fitted to elongated frame 13 to guide pipeline 2 along elongated frame 13; and a support assembly 16 designed to roll along bed 3 of body of water 4 and support the second end of elongated frame 13.

In other words, as shown in FIG. 1, the first end of laying ramp 6 is supported by vessel 5, and the second end rests on bed 3 of body of water 4 by means of support assembly 16.

In the example shown, support assembly 16 comprises members 17—more specifically, wheels—which roll along bed 3 of body of water 4.

In a variation not shown, each member 17 is defined by a track.

With reference to FIG. 2, support assembly 16 comprises two undercarriages 18 located, in use, on opposite sides of pipeline 2, and each preferably comprising two rolling members 17. And support assembly 16 comprises connecting devices 19 for connecting undercarriages 18 to elongated frame 13.

Each undercarriage 18 is powered by at least one motor 20, connected to members 17 and shown by the dash line in FIG. 1, to move support assembly 16 along bed 3 of body of water 4. Hydraulic motors have proved particularly suitable for this purpose, and, in the example shown, motor 20 is reversible to move support assembly 16 along bed 3 of body of water 4 in both the pipeline laying and abandoning direction D1, and the reverse direction D2 to direction D1.

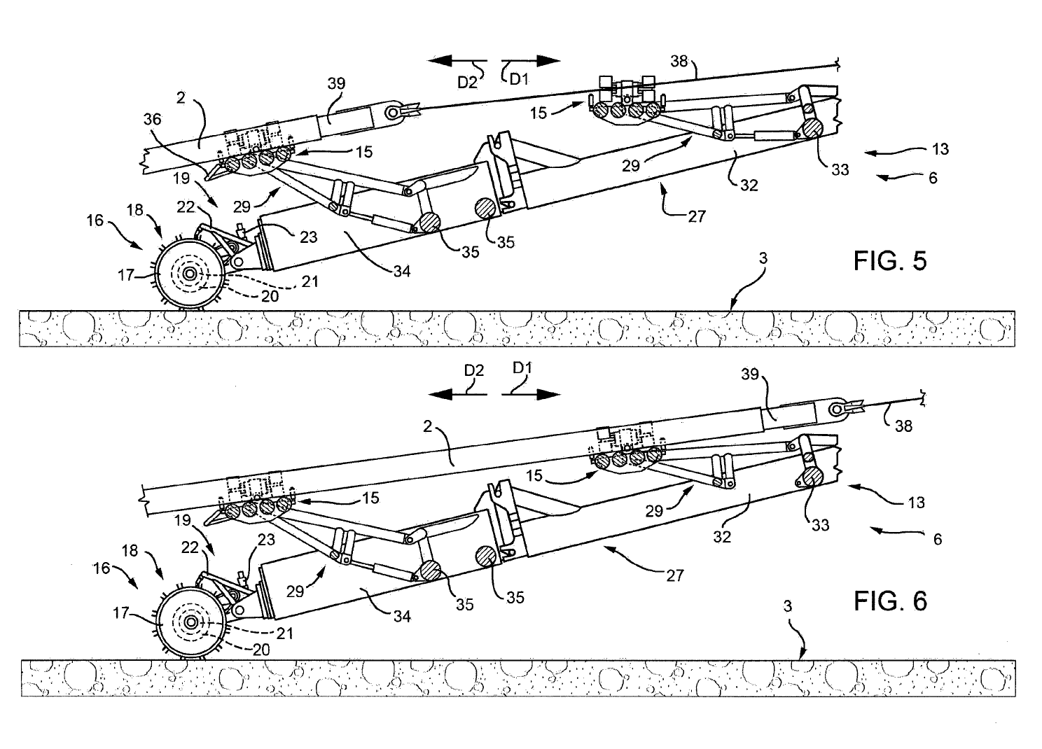

As shown more clearly in FIG. 5, support assembly 16 also comprises remote-controlled connecting devices 21, each for connecting motor 20 to rolling members 17.

If motor 20 is hydraulic, connecting device 21 is a system of valves that allows idling of the hydraulic motor and inversion of the rolling direction of members 17.

According to the present invention, each rolling member 17 can roll idly about its axis of rotation, or be powered by motor 20 with a given torque in either direction.

Powering support assembly 16 is a major advantage when working on a bed 3 with a surface structure that impedes travel of support assembly 16, and when reversing laying ramp 6 along bed 3 in direction D2.

Each connecting device 19 comprises a system of articulated levers 22, and a hydraulic cylinder 23.

In the preferred embodiment of the present invention, the length of hydraulic cylinder 23 is remote-controlled, so connecting device 19 adjusts the position of the second end of elongated frame 13 with respect to bed 3 of body of water 4.

Connecting device 19 is also designed to act as a shock-absorber.

With reference to FIG. 2, support assembly 16 is connected to vessel 5 by elongated frame 13 and a universal joint 24, so as to freely follow the topography of bed 3 of body of water 4 without inducing stress on vessel 5 and, in particular, on the point connecting laying ramp 6 to vessel 5.

Laying ramp 6 is hinged to hull 7 of vessel 5 at the well in hull 7, i.e. connecting members 14 of laying ramp 6 are connected to attachment 8 by hinge pins 25.

In a variation not shown, the laying ramp is connected directly to the vessel by a universal joint.

In the embodiment shown, elongated frame 13 comprises a frame portion 26 hinged to vessel 5, and a frame portion 27 connected to support assembly 16. Frame portions 26 and 27 are connected to each other by universal joint 24, and have elastic blocks 28 for cushioning contact between them.

Universal joint 24 prevents the rolling and pitching motion of vessel 5 from being transmitted to frame portion 27, and so reduces stress on the hinge between laying ramp 6 and vessel 5; and, vice versa, prevents transmission of stress produced by lateral slope of bed 3, and so reduces lateral stress on the hinge between laying ramp 6 and vessel 5.

Control mechanism 9 controls the position of frame portion 26 about the hinge axis, and hence the position of frame portion 27. Frame portion 26 is fitted directly with a guide device 15, which is adjustable in position by adjusting the position of frame portion 26 controlled by control mechanism 9, which actually controls the configuration of elongated frame 13.

The guide devices 15 fitted to frame portion 27 are connected to frame portion 27 by two respective control mechanisms 29 comprising respective actuators which, in the example shown, are double-acting hydraulic cylinders.

Constructionwise, frame portion 26 comprises two longitudinal members 30 connected by and cross members 31.

Frame portion 27 comprises two longitudinal members 32; cross members 33 connecting longitudinal members 32; and two further longitudinal members 34 connected to each other by two cross members 35, and fitted to and projecting from the second end of elongated frame 13.

Longitudinal members 34 are hollow and in the form of airtight, variable-buoyancy tanks; and the two undercarriages 18 are connected directly to the free ends of respective longitudinal members 34.

Each guide device 15 is in the form of a cradle for partly supporting the vertical load of the pipeline 2 span between vessel 5 and bed 3 of body of water 4, and for supporting the lateral loads of pipeline 2.

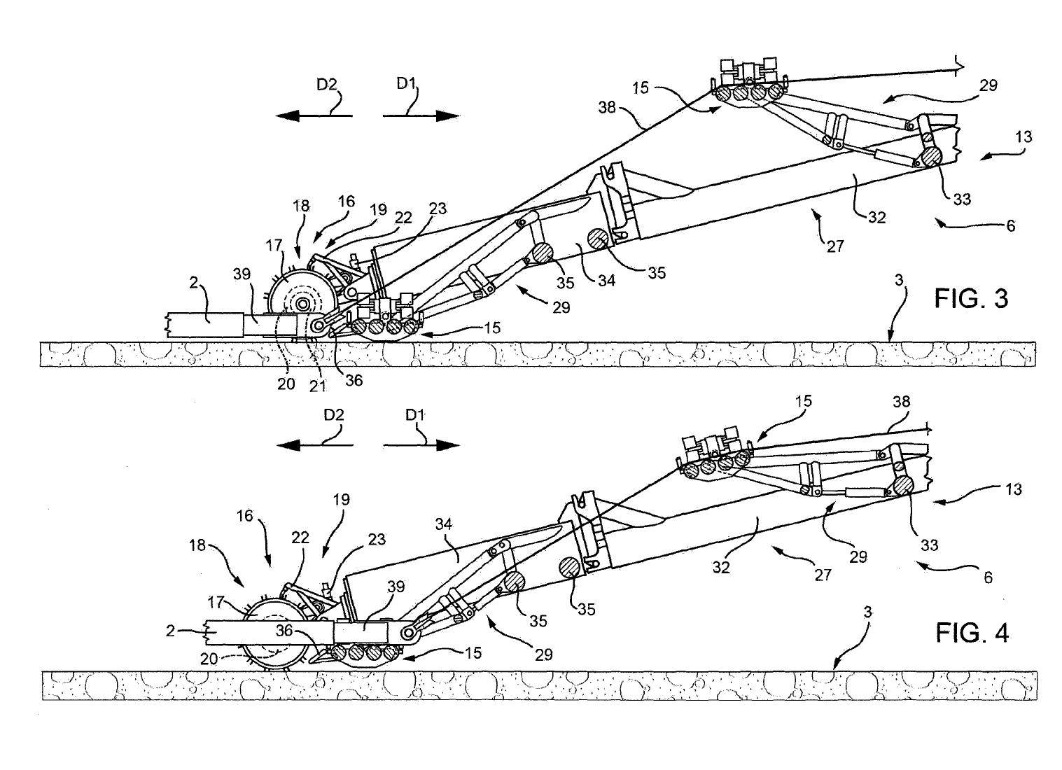

One of the two guide devices 15 fitted to frame portion 27 is connected to longitudinal members 32, and the other is connected to longitudinal members 34. To improve cooperation with pipeline 2 at any operating stage, i.e. when laying, recovering, or abandoning the pipeline, the guide device 15 fitted to longitudinal members 34—in the example shown the last guide device 15 —can be positioned under elongated frame 13 i.e. under longitudinal members 34 as shown in FIGS. 3 and 4, as well as over elongated frame 13 as shown in FIGS. 5 and 6. Cross members 35 are also arranged to enable pipeline 2 to be positioned at least partly beneath elongated frame 13, at the free ends of longitudinal members 34, as shown in FIG. 4.

The last guide device 15 comprises a chute 36, which rests on bed 3 and is wedge-shaped for insertion beneath pipeline 2 abandoned on bed 3 of body of water 4.

Control mechanisms 29 permit ample position adjustment of guide devices 15.

Vessel 5 preferably has no crane capable of reaching the end of laying ramp 6, and is moved forward by mooring lines not shown.

With reference to FIG. 1, vessel 5 comprises a winch 37 having a cable 38, and a gripping member 39 for gripping pipeline 2. Winch 37 is used for controlled abandoning and recovery of pipeline 2, and guide devices 15 are designed to guide cable 38.

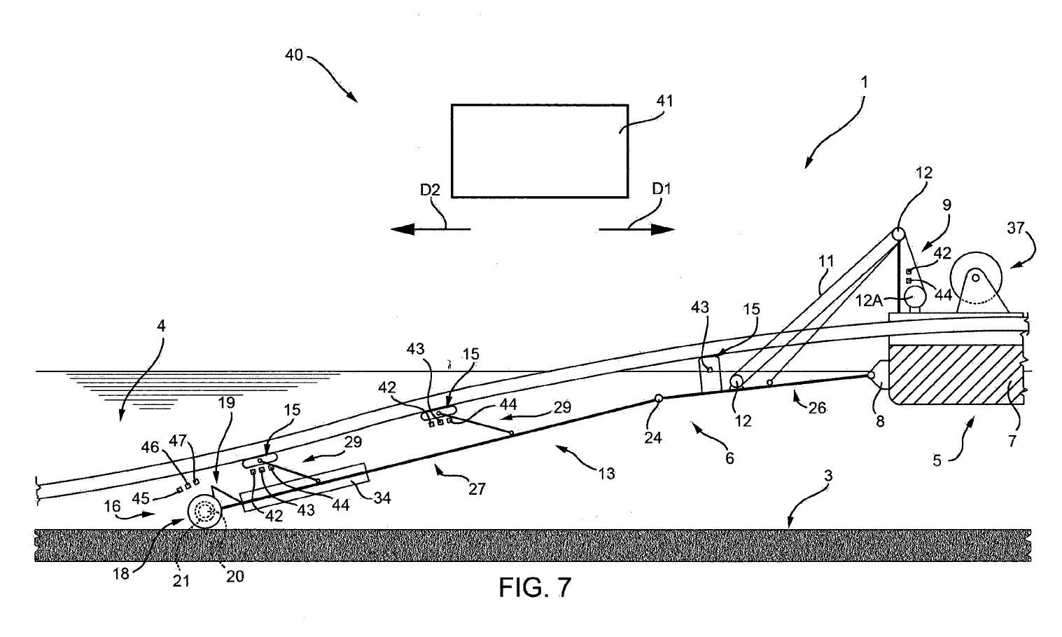

With reference to FIG. 7, vessel 5 comprises a control system 40 in turn comprising a control unit 41; and a number of sensors for controlling laying ramp 6 and winch 37 (FIG. 1). More specifically, control unit 41 is connected operatively to control mechanisms 9, 29, motors 20, connecting devices 19, connecting devices 21, longitudinal members 34, and winch 37 (FIG. 1). Each guide device 15 and relative control mechanisms 9, 29 are associated with a vertical load sensor 42, lateral load sensors 43, and a position sensor 44. Each undercarriage 18 is associated with a vertical load sensor 45, a depth sensor 46, and a torque sensor 47 for sensing the torque transmitted to members 17. Control unit 41 is configured to acquire the signals from sensors 42, 43, 44, 45, 46, 47, and calculate the configuration of laying ramp 6 and the stress exchanged between laying ramp 6 and pipeline 2. Control unit 41 is preferably located on vessel 5, and is also configured to control control mechanisms 9, 29, connecting devices 19, motors 20, connecting devices 21, and longitudinal members 34, i.e. the airtight variable-buoyancy tanks, as a function of the above sensor signals and reference parameters related to the characteristics of pipeline 2. Control unit 41 is configured to control laying ramp 6 in two modes: a load control mode, whereby each control mechanism 29 is set to operate at a given load, or rather within a given load range, and guide devices 15 assume configurations conforming with the set load conditions; and a position control mode, whereby guide devices 15 are manoeuvred independently of the load on them.

Load control mode is used at the laying stage, and position control mode at the controlled abandoning and recovery stages.

With reference to FIG. 1, laying unit 1 is moved in body of water 4 in direction Dl when laying and abandoning pipeline 2 on bed 3 of body of water 4 (FIG. 7), and in direction D2, opposite direction D1, when recovering pipeline 2 (FIG. 1) abandoned on bed 3 of body of water 4.

When moving in either direction D1, D2, laying ramp 6 is supported partly by vessel 5 and partly by bed 3 of body of water 4, and so adapts immediately to the depth of even a topographically uneven bed 3. This enables the free end of laying ramp 6 to be maintained close to, bed 3, to follow pipeline 2 constantly.

When working on a highly uneven bed 3, members 17 are connected by connecting devices 21 to motors 20 (FIG. 5), which assist in driving laying ramp 6 forward.

When working on a fairly smooth, compact bed 3, members 17 can roll idly about their respective axes of rotation, and laying ramp 6 is actually towed by vessel 5 in direction D1.

Longitudinal members 34, i.e. the airtight, variable-buoyancy tanks, serve to prevent excessive loads on bed 3, and to recover frame portion 27 to move laying ramp 6 into the safety configuration.

When laying the pipeline, guide devices 15 are positioned in load-control mode on the basis of the vertical loads on them. That is, control unit 41 maintains the vertical loads on the guide devices substantially constant (actually within respective given ranges). So, once the positions of guide devices 15 are defined to achieve the best configuration and minimize strain and stress on pipeline 2, guide devices 15 are adjusted automatically by respective control mechanisms 9, 29 to maintain the vertical loads between each guide device 15 and pipeline 2 substantially constant. Control mechanisms 29 also serve to absorb any shock or vertical load peaks. Because the configuration of laying ramp 6 varies alongside variations in the depth of bed 3, control unit 41 recalculates the best operating parameters of control mechanisms 9, 29 and connecting devices 19, which are actually also adjusting devices.

When pipeline 2 is abandoned on bed 3 of body of water 4 because of bad weather, laying unit 1 is able to recover the free end of pipeline 2 onto vessel 5 using laying ramp 6 and winch 37, as shown in the FIGS. 3, 4, 5 and 6 sequence. With reference to FIG. 3, guide devices 15 and control mechanisms 29 associated with at least frame portion 27 are position-controlled by control unit 41, and serve as hoisting devices to make up for the lack of a long-reach crane, which is not installed, to reduce the draft of vessel 5.

Control unit 41 also controls the position of guide devices 15 and respective control mechanisms 29 when controlled-abandoning pipeline 2.

When recovering pipeline 2, laying unit 1 is first moved in direction D2; members 17 are preferably driven by motors 20 to prevent frame portion 27 from swerving as it is reversed in direction D2; and guide device 15 is fully lowered, so chute 36 rests on bed 3 and, as it moves in direction D2, is inserted between pipeline 2 and bed 3. In other words, laying ramp 6 is inserted beneath pipeline 2, between pipeline 2 and bed 3. At the same time, the free end of pipeline 2 is connected to cable 38, which is guided by the last-but-one guide device 15 set to a maximum lift position, in which cable 38 has, and exerts pull with, a considerable vertical component to lift the free end of pipeline 2 off bed 3. In other words, the free end of pipeline 2 is lifted off bed 3 by the last guide device 15, which is operated like an excavator shovel inserted under the free end of pipeline 2, and by cable 38 connected to the free end of the pipeline and guided by the last-but-one guide device 15 used in the same way as a crane boom.

As shown in FIG. 4, once the free end of pipeline 2 is raised off bed 3, the last-but-one guide device is eased down to gradually align cable 38 with pipeline 2, and the last guide device 15 is eased up, as shown in FIG. 5, to further align cable 38 with pipeline 2 and insert pipeline 2 accurately inside the last-but-one guide device 15. Cable 38 thus exerts pull predominantly parallel to pipeline 2, and very little vertical lifting force. Greater lifting force at this stage would be harmful by detaching pipeline 2 from the last guide device 15. In fact, as shown in FIG. 5, a small downward component is even preferable at the next stage, until pipeline 2 is supported by at least two guide devices 15, as shown in FIG. 6.

When abandoning pipeline 2, the steps described with reference to FIGS. 3 to 6 are performed in reverse to ease the free end of pipeline 2 onto bed 3 of body water 4 by means of the last guide device 15 operated like an excavator shovel, and the last-but-one guide device 15 operated like a crane boom.

The present invention has numerous advantages: stable support of the laying ramp in very shallow water, with no risk of the ramp sinking into the bed, and with very little drag; reverse travel of the ramp in very shallow water; and effective guidance of high-specific-weight pipelines using a relatively small, lightweight laying ramp.

When laying the pipeline, the load-control mode has the advantage of minimizing stress between the pipeline and the laying ramp, the position of which is partly determined by the bed of the body of water. For which purpose, control mechanisms 29 allow extensive travel, in the order of 4 vertical metres. Position-control mode, on the other hand, is more advantageous at the early stages in recovering the pipeline, and the final stages in abandoning the pipeline.

The laying ramp according to the present invention is also highly versatile, not only when laying but also when abandoning and recovering the pipeline, which can be carried out with no need for a long-reach crane, which could not be supported by a shallow-draft vessel.

Clearly, changes may be made to the embodiment described of the present invention without, however, departing from the scope of the accompanying Claims.

1. A laying ramp for laying a pipeline on the bed of a body of water, the laying ramp comprising:
an elongated frame having a first and second end;
connecting members connecting the first end of the elongated frame to a vessel;
at least one guide device fitted to the elongated frame to guide the pipeline along the elongated frame; and
a support assembly comprising at least one undercarriage to roll along the bed of the body of water and support the second end of the elongated frame.

2. A laying ramp as claimed in claim 1, wherein the support assembly further comprises at least one motor for driving the undercarriage to move the support assembly along the bed of the body of water.

3. A laying ramp as claimed in claim 2, wherein the motor is reversible to move the support assembly along the bed of the body of water in two opposite directions.

4. A laying ramp as claimed in claim 1, wherein the support assembly further comprises at least one powered connecting device for connecting the undercarriage to the elongated frame to selectively adjust the distance between the undercarriage and the elongated frame, and the position of the second end of the elongated frame with respect to the bed of the body of water.

5. A laying ramp as claimed in claim 1, wherein the support assembly further comprises at least one shock-absorbing connecting device connected to the elongated frame.

6. A laying ramp as claimed in claim 1, further comprising a powered control mechanism for connecting the guide device to the elongated frame and adjusting the distance between the guide device and the elongated frame.

7. A laying ramp as claimed in claim 6, wherein the guide device comprises an end chute; the control mechanism being designed to position the chute on the bed of the body of water.

8. A laying ramp as claimed in claim 1, wherein the support assembly is connected to the vessel by the elongated frame and a universal joint.

9. A laying ramp as claimed in claim 8, wherein the elongated frame comprises:
a first frame portion hinged to the vessel; and
a second frame portion connected to the support assembly;
the first frame portion and second frame portion being connected to each other by the universal joint.

10. A laying unit for laying a pipeline on the bed of a body of water, the laying unit comprising:
a vessel movable on the body of water; and
a laying ramp as claimed in claim 1; the laying ramp being supported partly by the vessel, and partly resting on the bed of the body of water.

11. A laying unit as claimed in claim 10, wherein:
the laying ramp further comprises:
a number of guide devices arranged successively along the elongated frame; and
a number of control mechanisms, each associated with a respective guide device to adjust the position of the respective guide device; and
the laying unit further comprises:
a control system designed to acquire operating parameters of each guide device; and
a control unit designed to control the control mechanisms of the guide devices as a function of the parameters acquired.

12. A method of operating a laying unit, wherein the laying unit comprises a vessel; and a laying ramp which is supported partly by the vessel and rests partly on the bed of the body of water, the laying ramp comprising an elongated frame with a first and second end, a guide device fitted to the elongated frame, and a support assembly comprising at least one undercarriage supporting the second end of the elongated frame; the method comprising the step of moving the undercarriage along the bed of the body of water.

13. A method as claimed in claim 12, further comprising the step of moving the undercarriage along the bed of the body of water by means of a powered member.

14. A method as claimed in claim 12, further comprising the step of moving the undercarriage, by means of a powered member, along the bed of the body of water in a first direction or a second direction opposite the first direction.

15. A method as claimed in claim 12, further comprising the steps of:
moving the laying ramp towards the free end of a pipeline abandoned on the bed;
inserting the guide device between the bed of the body of water and the free end of the pipeline; and
lifting the free end of the pipeline off the bed by raising the guide device.

16. A method as claimed in claim 15, wherein:
the laying ramp further comprises a second guide device located between the first guide device and the vessel;
the vessel comprises a winch with a cable connectable to the free end of the pipeline; and
the method further comprises the steps of:
guiding the cable by means of the second guide device; and
positioning the second guide device, with respect to the first guide device, so as to exert lifting force on the free end of the pipeline by means of the cable.

17. A method as claimed in claim 12, further comprising the steps of:
supporting the pipeline along the laying ramp by means of a number of guide devices arranged successively along the elongated frame and operated respectively by a number of control mechanisms to adjust the position of the respective guide devices;
acquiring the operating parameters of each guide device; and
controlling the control mechanisms as a function of the parameters acquired.

18. A method as claimed in claim 17, further comprising the steps of:
determining the loads exchanged between the pipeline and the guide devices; and
controlling the control mechanisms to keep the loads exchanged between the pipeline and the guide devices within respective given ranges.
